(19) United States
(12) Patent Application Publication
(10) Pub. No.: US 2010/0260311 A1
(43) Pub. Date: Oct. 14, 2010

(54) ENCODING SYSTEM AND ENCODING METHOD

(75) Inventors: RONG-CONG HUNG, Tu-Cheng (TW); RONG-HWANG HORNG, Tu-Cheng (TW); SHEN-AN CHEN, Tu-Cheng (TW); YOU-REN LIN, Tu-Cheng (TW); SHIH-CHANG CHEN, Tu-Cheng (TW); YAW-SHEN LAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/475,507

(22) Filed: May 30, 2009

(30) Foreign Application Priority Data
Apr. 14, 2009 (CN) 200910301525.8

(51) Int. Cl. G01B 21/00

(52) U.S. Cl. 377/17

(57) ABSTRACT

An encoding system includes an absolute encoder, a converter, a storage system, and a processor. The converter is connected between the absolute encoder and the storage system to determine amplitudes of two encoding waveforms from the absolute encoder when a motor rotates. The storage system determines an angle through which the motor rotates between a first time and a second time, according to the amplitudes of the two encoding waveforms.

### BACKGROUND

1. Technical Field

The present disclosure relates to an encoding system and method for a motor.

2. Description of Related Art

An encoder is a device that converts motion into a sequence of digital pulses. By counting a single bit or by decoding a set of bits, the pulses can be converted to relative or absolute position measurements. Encoders are manufactured as absolute encoders, which produce a unique digital word corresponding to each rotational position of a shaft of a motor, and incremental encoders, which produce digital pulses as the shaft rotates, allowing measurement of a relative position of the shaft. The incremental encoder's production of digital pulses of a relative position of the shaft can adversely affect precision of position measurement.

### BRIEF DESCRIPTION OF THE DRAWINGS

FIG. 1 is a block diagram of an exemplary embodiment of an encoding system, including a processor, an absolute encoder, a converter circuit, and a storage system.

FIG. 2 is a block diagram of the storage system of FIG. 1.

FIG. 3 is a waveform diagram of two sine waves output from the absolute encoder of FIG. 1.

FIG. 4 is a coordinate diagram of amplitudes of the two sine waves of FIG. 3.

FIG. 5 is a waveform diagram of the two sine waves of FIG. 3 after adjustment, being converted by the converter circuit, and a sawtooth wave being processed by the processor.

FIGS. 6A, 6B and 6C are three parts of a flowchart of an exemplary embodiment of an encoding method.

### DETAILED DESCRIPTION

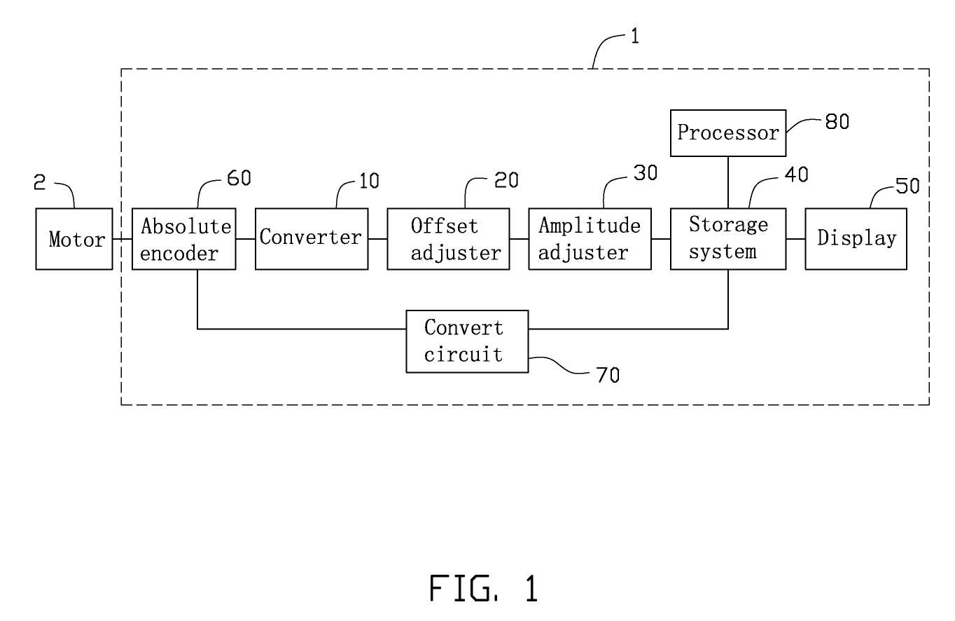

Referring to FIG. 1, an exemplary embodiment of an encoding system 1 is shown controlling a motor 2. The encoding system 1 includes a converter 10, an offset adjuster 20, an amplitude adjuster 30, a processor 80, a storage system 40, a display 50, an absolute encoder 60, and a converter circuit 70.

The absolute encoder 60, the converter 10, the offset adjuster 20, the amplitude adjuster 30, the storage system 40, and the display 50 are connected in series. The converter circuit 70 is connected between the absolute encoder 60 and the storage system 40. The processor 40 is connected to the storage system 40.

The absolute encoder 60 outputs encoding waveforms according to rotation of the motor 2. In one embodiment, the absolute encoder 60 may output two sine/cosine waveforms every time that the motor 2 rotates. In one example, a first sine wave 620 and a second sine wave 621 may be outputted by the absolute encoder 60 every time the motor 2 rotates.

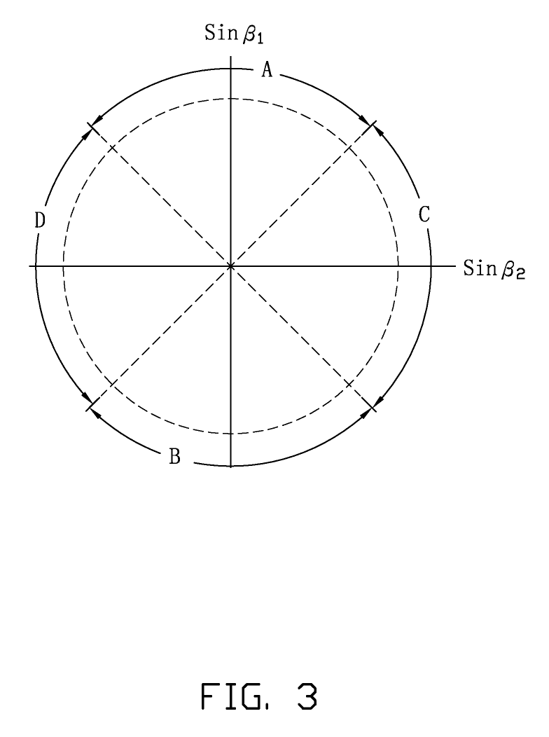

Referring to FIG. 3, the converter 10 receives the first sine wave 620 and the second sine wave 621 from the absolute encoder 60, and obtains amplitudes of the first and second sine waves 620, 621 at every time. The converter 10 transmits the amplitudes at every time of the first and second sine waves 620, 621 to the offset adjuster 20. In the illustrated embodiment, a phase difference between the first sine wave 620 and the second sine wave 621 is 90°. In other embodiments, the absolute encoder 60 may output two cosine waves to the converter 10 instead of two sine waves.

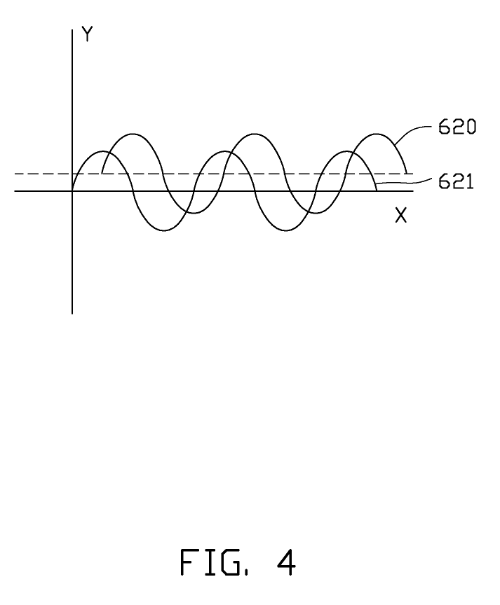

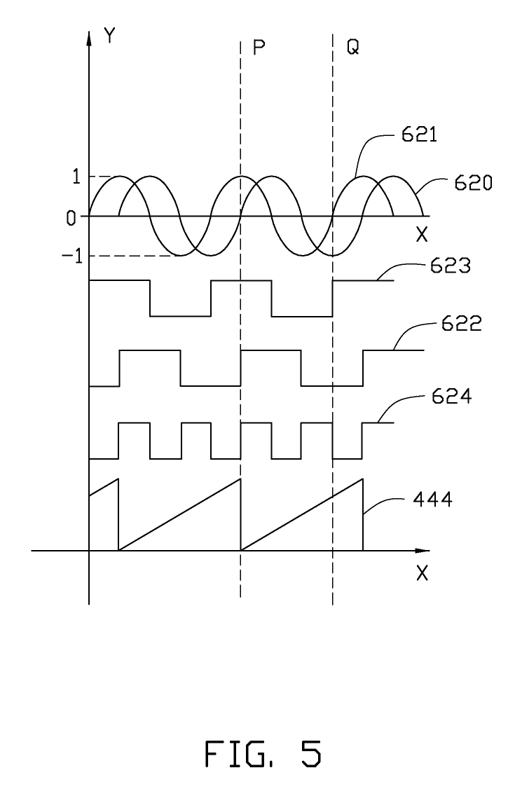

Referring to FIG. 4, the offset adjuster 20 adjusts centerlines of the first sine wave 620 and the second sine wave 620 to the same line, and constructs a coordinate system according to the amplitudes at every time of the first and second sine waves 620, 621. An x-axis of the coordinate system shows amplitudes of the second sine wave 621, and a y-axis of the coordinate system shows amplitudes of the first sine wave 620. In the illustrated embodiment, the coordinate system is divided into a first space A, a second space B, a third space C, and a fourth space D. The four spaces A, B, C, and D corresponds different formulae. A detailed description of the four spaces is described below. As shown in FIG. 3, if the centerlines of the two sine waves 620, 621 are horizontal centerlines, such as the broken line being the centerline of the first sine wave 620, and the X-axis is the centerline of the second sine wave 621, the offset adjuster 20 adjusts the centerline of the first sine wave 620 to coincide with the X-axis, as shown in FIG. 5.

The amplitude adjuster 30 adjusts the maximum amplitude of each of the first and second sine waves 620, 621 to one unit, the unit being a standard of measurement. In one example, one unit may denote 5 mm and two units may denote 10 mm.

The converter circuit 70 converts the first and second sine waves 620, 621 to a first digital pulse 622 and a second digital pulse 623 correspondingly, and transmits the first and second digital pulses 622 and 623 to the storage system 40. It may be understood that the first digital pulse 622 and the second digital pulse 623 may be rectangular waveforms of the first and second sine waves 620, 621, respectively.

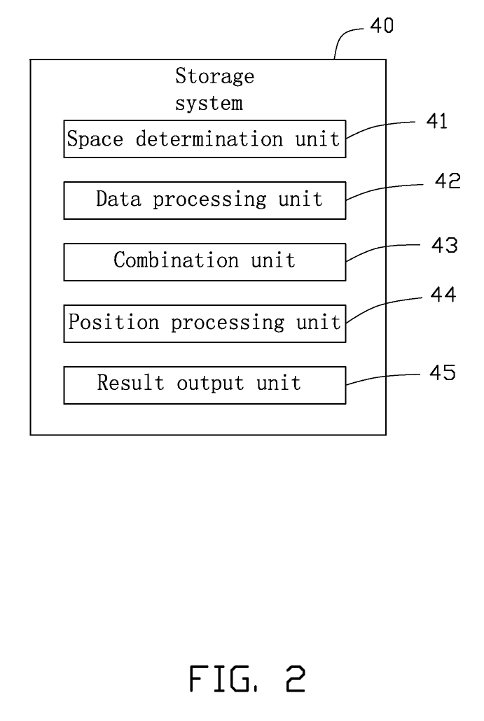

Referring to FIG. 2, the storage system 40 includes a space determination unit 41, a data processing unit 42, a combination unit 43, a position processing unit 44, and a result output unit 45. The processor 80 executes one or more computerized instructions for the space determination unit 41, the data processing unit 42, the combination unit 43, the position processing unit 44, and the result output unit 45.

The space determination unit 41 determines an amplitude Sin β1 of the first sine wave 620, an amplitude Sin β2 of the second sine wave 621 received by the storage system 40 at one time, and calculates an amplitude difference |Sin β1|−|Sin β2| between absolute values of the amplitudes Sin β1 and Sin β2, to ascertain the space that is a coordinate point of the amplitudes Sin β1 and Sin β2 at a time located according to Table 1, as stored in the data processing unit 42. Relationships of the amplitudes Sin β1, Sin β2, the first space A, the second space B, the third space C, and the fourth space D are shown in FIG. 4.

TABLE 1

Space

| | Space A | Space B | Space C | Space D |
|---|---|---|---|---|
| Sinβ1 | ≧0 | <0 | — | — |
| Sinβ2 | — | — | ≧0 | <0 |
| \|Sinβ1\| − \|Sinβ2\| | ≧0 | ≧0 | <0 | <0 |

The data processing unit 42 stores a plurality of functions: formula (1), formula (2), formula (3), and formula (4) as shown in Table 2. Each function corresponds to a space in Table 1.

TABLE 2

| | |
|---|---|
| Space A | tan α = Sinβ2/Sinβ1, θ = π/2 − α (1) |
| Space B | tan α = −Sinβ2/−Sinβ1, θ = 3π/2 − α (2) |
| Space C | tan α = Sinβ1/Sinβ2, θ = α (3) |
| Space D | tan α = −Sinβ1/−Sinβ2, θ = π/2 + α (4) |

The data processing unit 42 calculates angles α and θ according to the plurality of formulae in Table 2, and obtains a value of L according to formula (5):

L=N/2π×θ (5),

wherein N denotes a definition, namely 360 degrees divided into N parts, showing precision of the encoding system 1. In the embodiment, N is equal to about 2000.

Referring to FIG. 5, the data processing unit 42 calculates a plurality of angles α and θ according to the amplitudes Sin β1 of the first sine wave 620 and the amplitudes Sin β2 of the second sine wave 621 at a plurality of times received by the processor 40, to obtain a plurality of values of L. The data processing unit 42 draws a sawtooth wave 444 according to the plurality of values of L. It can be understood that the sawtooth wave 444 only denotes that the amplitudes of the first and second sine waves 620, 621 are continuous, but not discrete. As a result, the encoding system 1 is more accurate than an incremental encoder for determining an angle to which the motor 2 has rotated between a first time P and a second time Q. In other embodiments, the sawtooth wave 444 can be omitted, such that data processing unit 42 does not draw the sawtooth wave 444, but simply determines two values of L at two times to be measured.

The combination unit 43 combines the first digital pulse 622 and the second digital pulse 623 from the converter circuit 70 into a combined digital pulse 624.

The position processing unit 44 records a pulse number M of the combined digital pulse 624 between the first time P and the second time Q, determines the values of L of the first and second times P, Q as L^{P} and L^{Q} correspondingly, and determines a value S according to formula (6):

S=L^{Q}+Z×R−L^{P} (6)

wherein Z denotes a number of integrated sine waves between the first and second times, and P, Q, R denote a wavelength of the first sine wave 620, and R=N/2π×2π=N. Z is equal to [M/4], and [M/4] denotes an integer of M/4. It may be understood that an integrated first sine wave 620 can be converted to four pulses, such that the number of the sine waves between the first and second times P, Q is M/4, namely the number Z of integrated sine waves is [M/4].

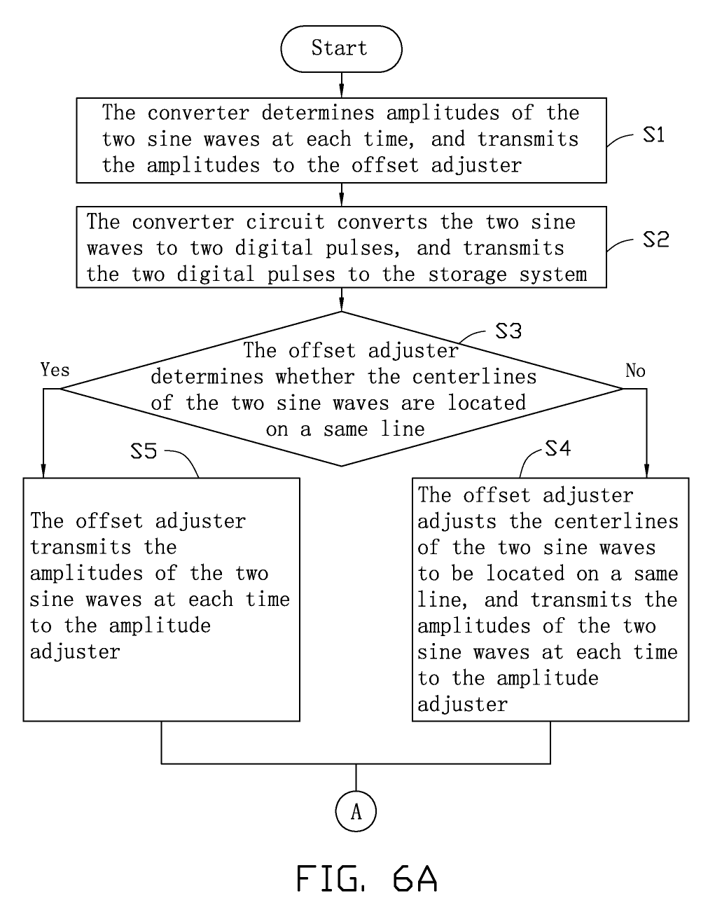

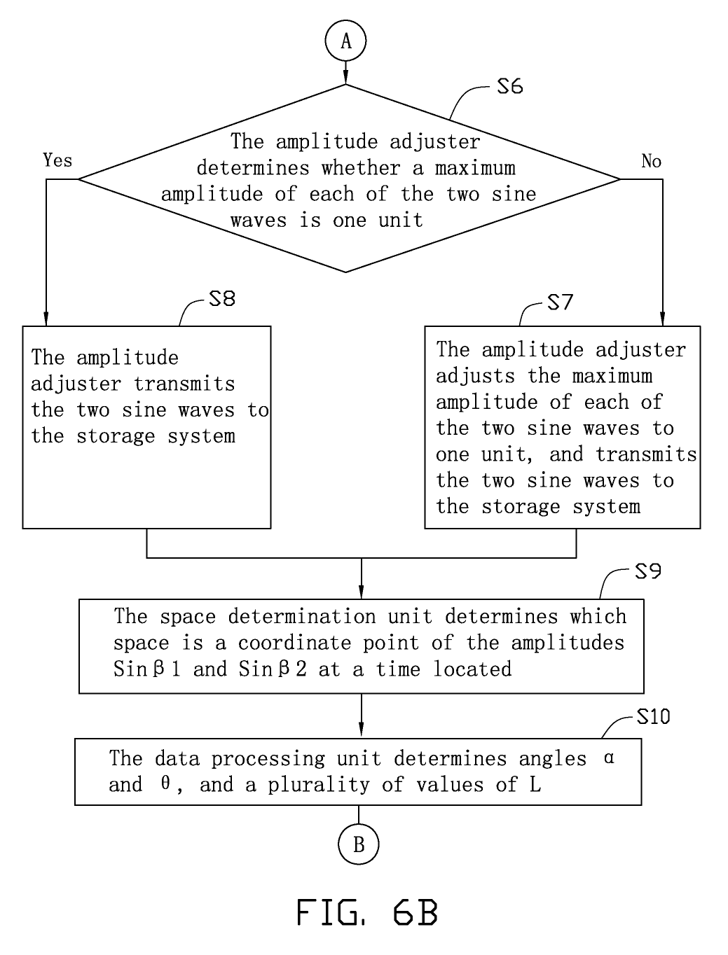

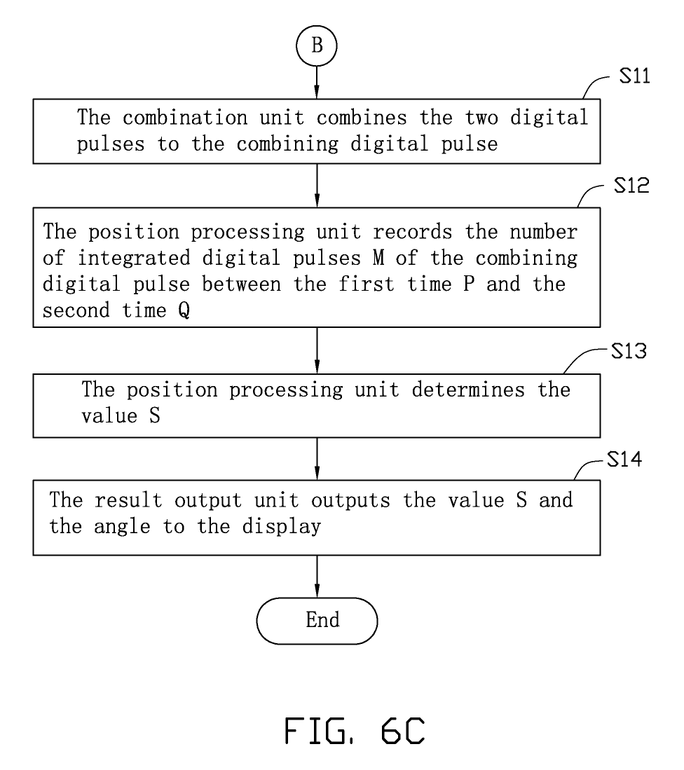

Referring to FIGS. 6A, 6B and 6C, an exemplary embodiment of an encoding method for determining the angle to which the motor 2 has rotated between the first and second times P, Q includes the following steps.

In step S1, the converter 10 determines amplitudes of the first and second sine waves 620, 621 at every time, and transmits the amplitudes to the offset adjuster 20.

In step S2, the converter circuit 70 converts the first and second sine waves 620, 621 to first and second digital pulses 622, 623 respectively, and transmits the first and second digital pulses 622, 623 to the storage system 40.

In step S3, the offset adjuster 20 determines whether the centerlines of the first and second sine waves 620, 621 are located on a same line. If the centerlines of the first and second sine waves 620, 621 are not located on a same line, the flow moves to step S4. If the centerlines of the first and second sine waves 620, 621 are located on a same line, the flow moves to step S5.

In step S4, the offset adjuster 20 adjusts the centerlines of the first and second sine waves 620, 621 to be located on a same line, constructs a coordinate system of amplitudes of the first and second sine waves 620, 621, and transmits the amplitudes of the first and second sine waves 620, 621 after being adjusted at every time to the amplitude adjuster 30. The coordinate system is divided into four spaces, and the flow moves to step S6.

In step S5, the offset adjuster 20 constructs a coordinate system of amplitudes of the first and second sine waves 620, 621, and transmits the amplitudes of the first and second sine waves 620, 621 at every time to the amplitude adjuster 30. The coordinate system is divided into four spaces, and the flow moves to step S6.

In step S6, the amplitude adjuster 30 determines whether a maximum amplitude of each of the first and second sine waves 620, 621 is one unit. As mentioned above, one unit may denote 5 mm. If the maximum amplitude of each of the first and second sine waves 620, 621 is not one unit, the flow moves to step S7. If the maximum amplitude of each of the first and second sine waves 620, 621 is one unit, the flow moves to step S8.

In step S7, the amplitude adjuster 30 adjusts the maximum amplitude of each of the first and second sine waves 620, 621 to one unit, and transmits the first and second sine waves 620, 621 to the storage system 40. The flow moves to step S9.

In step S8, the amplitude adjuster 30 transmits the first and second sine waves 620, 621 to the storage system 40.

In step S9, the space determination unit 41 determines which space is a coordinate point of the amplitudes Sin β1 and Sin β2 of the first and second sine waves 620, 621 at a time located according to Table 1 stored in the data processing unit 42.

In step S10, the data processing unit 42 determines angles α and θ according to the plurality of formulae in Table 2 of the first and second sine waves 620, 621 at every time, determines a plurality of values of L according to the formula (5) to draw the sawtooth wave 444, and determines the values of L^{P} and L^{Q} at the first time P and the second time Q correspondingly.

In step S11, the combination unit 43 combines the first digital pulse 622 and the second digital pulse 623 into the combined digital pulse 624.

In step S12, the position processing unit 44 records the number of integrated digital pulses M of the combined digital pulse 624 between the first time P and the second time Q.

In step S13, the position processing unit 44 determines the value S according to formula (6). According to characters of the absolute encoder 60 and the value S, an angle to which the motor 2 has rotated between the first time P and the second time Q is obtained. For example, if N is equal to about 2000, S is equal to about 1000 and the angle to which the motor 2 has rotated between the first time P and the second time Q is equal to (S/1000)*10°.

In step S14, the result output unit 45 outputs the value S and the angle to which the motor 2 has rotated to the display 50 to show the result.

One example of how to determine the rotational angle the motor 2 has rotated between the first time P and the second time Q is disclosed below. Referring to FIG. 5, the amplitude of the first sine wave 620 at the first time P is 0, and the amplitude of the second sine wave 621 at the first time P is one unit 1. The space determination unit 41 determines that the coordinate point (1, 0) of the amplitudes of the second and first sine waves 621, 620 at the first time P is located at the third space C according to Table 1. The data processing unit 42 determines that the angle θ is equal to about zero according to the formula (3) in Table 2, and the value of L at the first time P is L^{P}=N/2π×θ=0 according to the formula (5).

The amplitude of the first sine wave 620 at the second time Q is about −1, and the amplitude of the second sine wave 621 at the second time Q is about 0. The space determination unit 41 determines that the coordinate point (0, −1) of the amplitudes of the second and first sine waves 621, 620 at the second time Q is located at the second space B according to Table 1. The data processing unit 42 determines that the angle θ is equal to about 3π/2 according to the formula (2) in Table 2, and the value of L at the second time Q is L^{Q}=N/2π×θ=2000/2π×3π/2=1500 according to the formula (5).

The position processing unit 44 records that there are 3 pulses in the combined digital pulse 624 between the first time P and the second time Q, namely, M is equal to 3. According to the formula (6), the value S is S=1500+[¾]×2000−0=1500. As a result, the motor 2 has rotated 15 degrees, between the first time P and the second time Q.

In the embodiment, because the centerlines of the first and second sine waves 620, 621 are adjusted by the offset adjuster 20, and the amplitudes of the first and second sine waves 620, 621 are adjusted by the amplitude adjuster 30, the processor 80 processes the first and second sine waves 620, 621 more conveniently. In other embodiments, the offset adjuster 20 and the amplitude adjuster 30 can be canceled. In addition, the position processing unit 44 can determine the number of cycles of the first sine wave 620 between the first time P and the second time Q, via the time between the first time P and the second time Q being divided by a cycle time of the first sine wave 620 or the second sine wave 621. As a result, the first digital pulse 622, the second digital pulse 623, and the combined digital pulse 624 can be omitted, as can the converter circuit 70.

The foregoing description of the exemplary embodiments of the disclosure has been presented only for the purposes of illustration and description and is not intended to be exhaustive or to limit the disclosure to the precise forms disclosed. Many modifications and variations are possible in light of the above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An encoding system to measure an angle through which a motor rotates between a first time and a second time, the encoding system comprising:
a processor;
a storage system connected to the processor and storing one or more computerized instructions being executed by the processor;
an absolute encoder to output two encoding waveforms according to rotation of the motor at the first time and the second time;
a converter connected between the storage system and the absolute encoder, to determine amplitudes of the two encoding waveforms, and to output the amplitudes to the processor;
wherein the storage system comprises:
a data processing unit to store the amplitudes of the two encoding waveforms, store differences between absolute values of the amplitudes of the two encoding waveforms at the first time and the second time, store relationships of the amplitudes, store spaces of a coordinate system about the amplitudes of the two encoding waveforms at the first time and the second time, and store a function of each space;
a space determination unit to determine a coordinate point of the amplitudes of the two encoding waveforms at the first time and the second time according to the amplitudes of the two encoding waveforms at the first time and the second time; and
a position processing unit to record a number of each of the integrated encoding waveforms between the first time and the second time, determine a value S, and the angle which the motor rotates between the first time and the second time.

2. The encoding system of claim 1, wherein the two encoding waveforms are two sine waveforms or two cosine waveforms.

3. The encoding system of claim 1, wherein the data processing unit selects a corresponding function according to the space, and determines a first angle θ and a second angle θ at the first and second times, and values of L at the first and second times, according to a formula
L=N/2π×θ, where N denotes a definition of the encoding system.

4. The encoding system of claim 1, wherein the position processing unit determines the value S according to a formula of S=L^{Q}+Z×R−L^{P}, wherein Z denotes the number of each of the integrated encoding waveforms between the first time and the second time, L^{P} denotes a value of L at the first time, L^{Q} denotes a value of L at the second time, R denotes a wavelength of each of the encoding waveforms, and the angle to which the motor rotates is (S/1000)*10°.

5. The encoding system of claim 1, further comprising an amplitude adjuster connected between the converter and the storage system, wherein the amplitude adjuster adjusts the maximum amplitude of each of the encoding waveforms to be the same, and transmits the two encoding waveforms to the storage system.

6. The encoding system of claim 1, further comprising an offset adjuster connected between the converter and the storage, wherein the offset adjuster adjusts centerlines of the two encoding waveforms to be on a same line, and transmits the two encoding waveforms to the storage system, wherein a coordinate system for the amplitudes at each time of the two encoding waveforms is constructed by the offset adjuster.

7. The encoding system of claim 1, further comprising a converter circuit connected between the absolute encoder and the storage system, to convert the two encoding waveforms to two digital pulses, and transmit the two digital pulses to the storage system; wherein the storage system further comprises a combination unit to combine the two digital pulses into a combined digital pulse, and the position recording unit is to record the pulse number of the combined digital pulse between the first time and the second time.

8. An encoding method to measure an angle through which a motor rotates between a first time and a second time, the encoding method comprising:
determining amplitudes of two encoding waveforms that a motor rotates between the first time and the second time, wherein a phase difference between the two encoding waveforms is 90 degrees;
transmitting the amplitudes to a storage system, wherein the storage system stores the amplitudes of the two encoding waveforms, stores differences between absolute values of amplitudes at the first time and the second time of the two encoding waveforms, store relationships of the amplitudes, stores spaces of a coordinate system for the amplitudes at the first time and the second time of the two encoding waveforms, and stores a function of each space, wherein the storage system stores one or more computerized instructions being executed by the processor;
determining which space is a coordinate point of the amplitudes of the two encoding waveforms at determined time;
recording a number of each of the integrated encoding waveforms between the first time and the second time, and determining a value S between the first time and the second time, and the angle to which the motor rotates between the first time and the second time.

9. The encoding method of claim 8, wherein the two encoding waveforms are two sine waveforms or two cosine waveforms.

10. The encoding method of claim 8, wherein determining the space and recording the number further comprising:
determining a first angle θ at the first time and a second angle θ at a second time, and values of L at the first and second time according to a formula of L=N/2π×θ, N denotes a definition of the encoding system.

11. The encoding method of claim 8, wherein the value S between the first time and the second time is determined according to a formula of S=L_{Q}+Z×R−L_{P}, wherein L_{P} denotes a value of L at the first time, L_{Q} denotes a value of L at the second time, R denotes a wavelength of each, Z denotes the number of each of the integrated encoding waveforms between the first time and the second time.

12. The encoding method of claim 8, wherein determining amplitudes of two encoding waveforms at each time further comprises adjusting centerlines of the two encoding waveforms to be on a same line, and transmitting the two encoding waveforms to the storage system.

13. The encoding method of claim 8, further comprising, after determining amplitudes of two encoding waveforms at every time that the motor rotates, adjusting the maximum amplitude of each of the two encoding waveforms to be the same, and transmitting the two adjusted encoding waveforms to the storage system.

14. The encoding method of claim 8, wherein recording the number of each of the two encoding waveforms between the first time and the second time further comprises:
converting the two encoding waveforms to two digital pulses, and transmitting the two digital pulses to the storage system;
combining the two digital pulses to a combining pulse; and
recording a pulse number M of the combined digital pulse between the first time and the second time, and [M/4] is equal to Z, wherein [M/4] denotes an integer of M/4.
